(19) United States
(12) Patent Application Publication
(10) Pub. No.: US 2007/0106540 A1
(43) Pub. Date: May 10, 2007

(54) BUSINESS METHOD, ELECTRONIC UNIT AND SOFTWARE SYSTEM FOR ADVERTISING AND REAL ESTATE TRADE INTERMEDIATION

(76) Inventor: Vladimir Kovalcik, Hlohovec (SK)

Correspondence Address: VLADIMIR KOVALCIK, FRASTACKA 17, HLOHOVEC, 92001, SK

(21) Appl. No.: 11/615,055

(22) Filed: Dec. 22, 2006

(30) Foreign Application Priority Data
Jan. 1, 2006 (SK) 1-2006
Aug. 21, 2006 (SK) 121-2006
Oct. 6, 2006 (SK) 136-2006

(51) Int. Cl. G06Q 40/00

(52) U.S. Cl. 705/4

(57) ABSTRACT

A specific business method, an electronic unit and software system for trade intermediation, when an effective tool on real estate market is trading with warranted real estate transaction services, time-limited conditional option commission blank form and extra parte mediation reward. Such a business method could be supported by network, reference or direct marketing. Insurance like business—the profit is gained from unrealized transactions, but for unconsumed services money back guarantee at nominal price level could be granted by using multilevel price marketing.

### FIELD OF THE INVENTION

The present invention relates to a specific business method, a trading system, an electronic unit and a software system for advertising and trade intermediation, when an effective tool on a rigid market, for example real estate, is trading with a warranted real estate transaction service and an intermediation reward in embodiment or entitlement connected to the assignable time-limited conditional commission blank form, preferably Blank Option & Bill of Exchange (BOBE) form.

An advertising is mediated by a method, an electronic unit or a software system and supported by extra parte commission using network, reference or direct marketing.

The subject-matter of the invention is applicable in the area of software system development, marketing, trading with various commodities by using electronic or printed forms, information processing, advertising and financial transactions using electronic networks.

### BACKGROUND OF THE INVENTION

A collecting and distributing of actual price information used in advertising intermediated by the Internet is a problem often solved and used in many areas of trade. Market price information is crucial for a right business investment decision.

Price of intermediation services is traditionally derived from property price. Costs of intermediation business are derived from advertisement costs, ownership transfer fees and charges, taxes and other service costs. Real estate agent service prices are derived from the real estate prices, but generally—intermediation costs do not depend on a property price. An agent reward is traditionally connected to a property price, or it is solid, commonly applicable after a successful ownership transfer.

Management of trading transactions from the point of view of cost cutting at sufficient assurance on the side of a seller, a mediation agent and a buyer, costs acceptability and fulfilment of law and regulation requirements are still an unfulfilled need in many branches mainly on the international level. Implementation of an effective international or regional trading process on a rigid market is a long-term problem in many branches. Such a branch is a real estate business, antiques, etc.

Next problem is to perform trading transactions intermediated by the Internet on regulated markets. Electronic unit and software system processing of advertisements have concentrated on real estate presentations so far, with information on a nonbinding price, without a possibility of concluding a business contract worldwide. Advertisements and auctions are well known.

Legal limitations are in a business with shares, options, real estate, etc. worldwide. A suitable financial instrument, embodiment, entitlement for an off-line or on-line electronic business, trade is needed for enabling a transparent, simple, legal, internationally acceptable and clear transfer of rights to an intermediation reward and an offered property or services with a possibility of creating pool of such entitlements.

An utilization of the electronic network, for example the Internet, for processing electronic interaction at buying and selling of real estates is solved in the patent U.S. Pat. No. 5,664,115 issued to Fraser. The system of collecting, distribution and use of information intermediated by the Internet in the area of commercial real estates is published in the patent U.S. Pat. No. 6,871,140 issued to Florance. U.S. Pat. No. 6,321,202 issued to Reveis discloses a method includes the steps of receiving and storing data relating to a plurality of contacts including buyers and sellers of real estate, receiving and storing data relating to a plurality of vendors. In prior art, there are well known firm connections of an option and a commission in the finance branch (option commissions). Progressive approach at solution of relations between an option and a commission in the real estate branch by creating pool of non-time-limited commission entitlements firmly connected to property is disclosed by patent U.S. Pat. No. 6,615,187 issued to Ashenmil. The method for monitoring the strength of a real estate market and making lending and insurance decisions there from is disclosed in U.S. Pat. No. 5,636,117 issued to Rothstein. U.S. Pat. No. 6,684,196 issued to Mini discloses method and apparatus for transactions between buyer and seller via the network to a plurality of real estate services. U.S. Pat. No. 6,751,596 issued to Hastings, and US application 20040167798, disclose method for tracking, monitoring, and supporting self-procurement of real estate. U.S. Pat. No. 5,950,175 issued to Austin discloses a data processing system for managing a plurality of discrete accounts. Each account provides a swap between a property holder and the plan manager wherein the holder dilutes their exposure to the real estate market by exchanging future appreciation of the property for a current cash flow stream. The system thereafter implements the packaging of plural accounts into baskets of real estate assets and sells this real estate exposure to the institutional market. U.S. Pat. No. 6,134,533 issued to Shell discloses a server system for multi-level vending of any electronically transferable product through a communications network directly to a customer's computer. U.S. Pat. No. 6,401,070 issued to McManus discloses method and system for estimating real estate property values based on repeat sales model. U.S. Pat. No. 6,594,633 issued to Broerman discloses a real estate computer network facilitates a transaction between a buyer and a seller by electronically communicating between the parties and third parties such as a real estate facilitating entities over a network. U.S. Pat. No. 6,954,738 issued to Wang discloses an enforceable property right and a system for controlling the manner of use of an item in accordance with usage rights. The enforceable property right includes an item ticket having a security mechanism incorporated therein and specifying an item for which the item ticket can be redeemed and a license associated with the item ticket. The license includes usage rights specifying a manner of use for redeeming the item ticket and a mechanism for unlocking said security mechanism.

### SUMMARY OF THE INVENTION

By developing an electronic unit and its management advertising software system, we have surprisingly found out a financial, business, technical and software system solution, which fulfils requirements of a high effective functionality at development of a new mediation market and a business environment. A sum of successful real estate transfers in limited time is lower, than a sum of offered real estates.

We have surprisingly found out method, electronic unit and software system suitable by using a time-limited conditional commission blank form connected to one embodiment or entitlement to warranted real estate transaction services and an intermediation reward to reach aimed high effective functionality on mediation and information market. After use the time-limited commission form could be related to the right to buy any property, preferably real estate, to the right to warranted authorized real estate service and/or intermediation reward.

Simple national, regional or international transfer of such a whole embodiment, entitlement, or its part is granted by internationally accepted transfer of bill of exchange (indosament, endorsement). When the trade with time-limited option commission in blank form, preferably Blank Option and Bill of Exchange (BOBE) form is supported by direct or reference marketing, using multilevel prices, then a pure extra parte mediation reward could be granted.

A blank time-limited option commission versions or forms are issued, distributed, sold as warranted mediation services at price level deeply under market average while issued, distributed and sold as insurance tool, item, subject or instrument.

Legal status of property and property itself is advertised and registered on electronic unit, preferably on registrar electronic portal by Registrar. Time-limited blank commission forms are issued by Issuer. Registrar and Issuer could be the same business entity or subject.

BOBEs are issued, distributed and sold at a nominal price level to agreement clients and at an OTC price level on the free market.

### DETAILED DESCRIPTION OF THE INVENTION

Functional tools as a commission, an option, a bill of exchange, and the price of a commission, the price of an option, the price of a bill of exchange, the price of the whole entitlement or embodiment and the mediation reward, compensation, provision, or their technical equivalents, serving as trading items or subjects on the real estate intermediation market.

We have surprisingly found out that it is suitable to use an assignable time-limited conditional blank commission form, preferably time-limited option and blank commission form, more preferably a time-limited Blank—Option & Bill of Exchange—form (BOBE), connected to one embodiment, entitlement, enabling utilize licensed, warranted, assured, insured real estate agent service, preferably warranted real estate transaction service, needed for ownership, lease or rights transfer, to reach aimed high effective functionality on real estate and price information market.

A time-limited assignable blank option or a time-limited assignable blank commission version, preferably time-limited assignable blank option commission, more preferably a time-limited assignable blank option and a bill of exchange in a printed or in an electronic mode, are traded on the market independently from any property, when connected to entitlement, embodiment, or instrument for unified, standardised, warranted, assured or insured intermediation services, preferably warranted real estate transaction services, more preferably licensed real estate transaction services, needed for ownership transfer according to local law and regulation requirements. Such embodiment, entitlement, or instrument is subject of trade on intermediation services market, before any connection to buying, leasing or selling any real property.

When said blank forms is completed, filled up whole or only its part, the warranted, licensed, assured or insured service is consumed and such entitlement becomes a subject of property, lease or rights market pushed or pulled by trade with intermediation reward. For example at an option for warranted real estate transaction services—it is about a way of a reward realization on the agent market and not about the real estate purchase itself. It is about commission and transaction services trading and not about a reward for an agent in connection with concrete real property. The bill of exchange (promissory note or draft) represents an unconditional platform for trade with an intermediation reward transferable by endorsement (indosament) or blank endorsement. A lot of business cases arise from the combination of the introduced time-limited conditional and unconditional tools. Solutions and examples are displayed by using off-line forms as in FIG. 3, where option and bill of exchange are firmly connected together or separable as in FIG. 4. Options could be exercised by any holder, for example by property buyer, licensed real estate agency, seller, etc., according to local laws and regulation requirements.

The blank option or blank commission form, preferably blank option commission form, more preferably option and bill of exchange in blank form connected to embodiment or entitlement is suitable to represent an advertising, an ownership transfer service, and other costs of services, fees and charges connected to the intermediation business, preferably on real estate market issued or distributed as a part of entitlement or embodiment of warranted, guaranteed, pre-paid, insured services and issued, distributed, sold, collected, archived, recorded individually or in packages, unlimited or preferably limited series, without or preferably with the time limitations.

Such as these business instruments issued, sold or distributed as assignable, transferable insurance tool enable to receive the profit from unrealized transfers. A BOBE associated with embodiment, entitlement of warranted advertisement and ownership transfer service is consumed after its use: filled up, completed, signed or after registration of property by Registrar, publication of advertisement. Licensed transfer services could be outsourced from local, regional, national or international certified agencies and paid (settlement) after successful ownership transfer according to local law and regulation requirements.

A sum of successful real estate transfers in limited time is lower, than a sum of offered real estates. From financial point of view this method support insurance like business—the main profit is gained from unrealized transactions, but unconsumed intermediation services, unused BOBE, could be collected and a time-limited money back guarantee could be granted for unconsumed services at 100% nominal price level, or lower, by using of multilevel price marketing.

It is advantageous when a BOBE is exercised by property buyer—new property owner according to FIG. 1 or FIG. 2, because the mediation process is simplified.

An assignable time-limited option to use said warranted, insured, assured real estate transaction services, and a assignable time-limited blank commission form, connected to entitlement to warranted real estate transaction services are a subject of trade by creation of a collection or a pool of such embodiments or entitlements (securization).

Simple transfer of such forms, embodiments, or entitlements is granted by internationally accepted endorsement (indosament).

There are minimal two kinds of clients: (1) outsourced real estate agencies or legal agents authorized or licensed to provide ownership, lease or rights transfer service according to local law and regulations, and (2) business entities, BOBE buyers/holders, active regionally, nationally or internationally on the field of real estate.

A clear legal status of property is necessary condition for successful transfer of ownership. The legal status and property itself is registered and advertised on registrar portal by clients or by Registrar. Using multilevel marketing prices Issuer issues, distributes, or sales BOBE at a nominal price level for agreement client and an OTC (over-the-counter) price level on the free market.

At utilizing of support marketing a number of business entities is pushed or pulled by network, reference or direct marketing, when any other person, preferably Registrar or Issuer, independently from buyer or seller of a property, grants conditional extra parte commission, compensation, discount or mediation reward.

An electronic unit and software system with a small amount of active fields is able to achieve high effectiveness at creation of a progressive business environment and sophisticated international mediation services market. The realization itself runs in the mode of electronic advertising, biding, auction or partly without using an electronic medium.

A specific method, an electronic unit and software system are preferably usable in the field of real estate, precious stones, antiques and other fields of goods and services, when licensed or warranted assistance is needed.

We have surprisingly found out that the connection of an electronic unit and software system with the above mentioned business method functionality and the methods of network, reference, multilevel, direct or other support-marketing, is able to serve as an efficient toll for collecting, sorting, evaluating, and distribution of actual price information and create a information environment derived from successful transaction conditions and price information.

It is advantageous to support said method of insured transaction services by creating pool of such time-limited transferable conditional commission blank forms connected to said embodiments or entitlements and using the electronic network, electronic bank clearing or equivalent system. That enables cost-cutting mainly in the international trading.

### DESCRIPTION OF THE DRAWINGS

FIG. 1—assignment of BOBE by seller; trading flow with increasing option price; option exercised by buyer.

FIG. 2—assignment of BOBE by buyer, trading flow with increasing price of bill of exchange; option exercised by buyer.

FIG. 3—blank time-limited transferable option commission off-line form with function fields: option to buy a property, option to exercise the bill of exchange, bill of exchange (a vista), option and bill of exchange firmly connected together, etc.

FIG. 4—blank time-limited transferable assignable option off-line form with function fields: option to buy property, bill of exchange (a vista), etc.

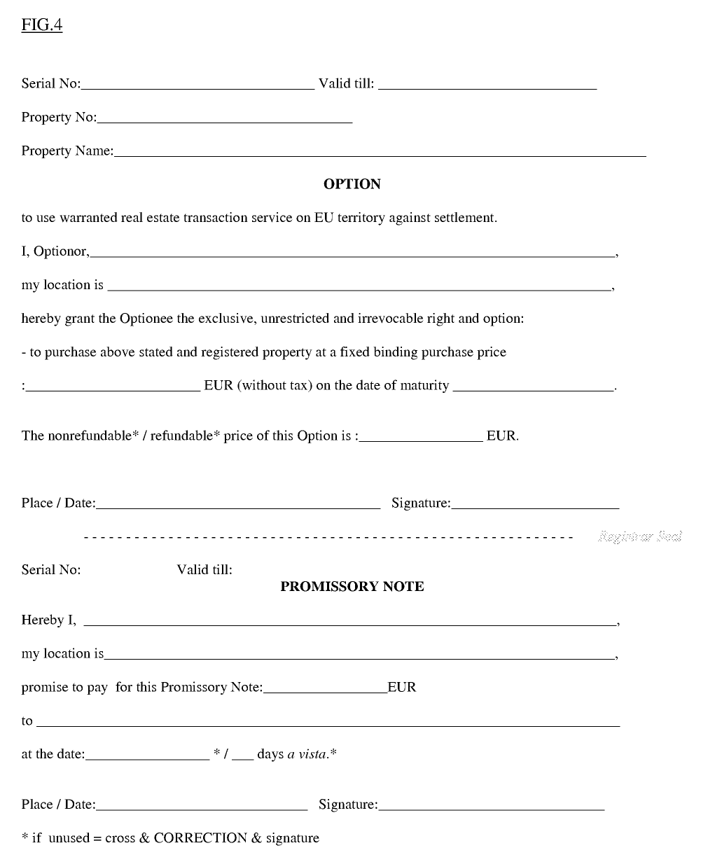

### EXAMPLE NO. 1

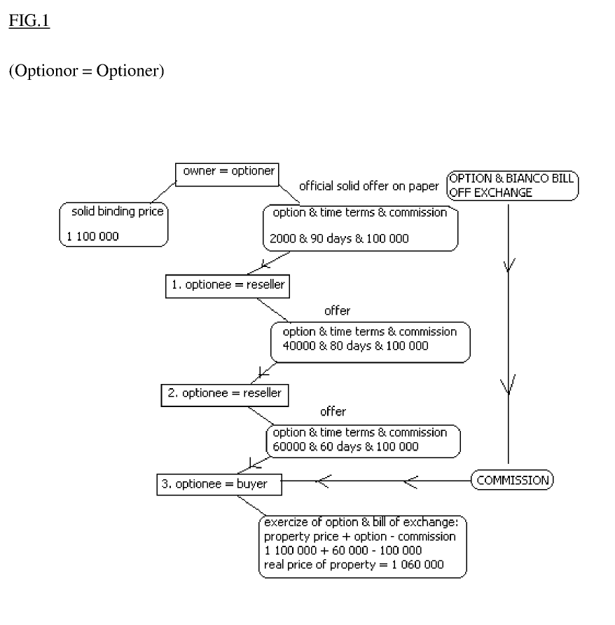

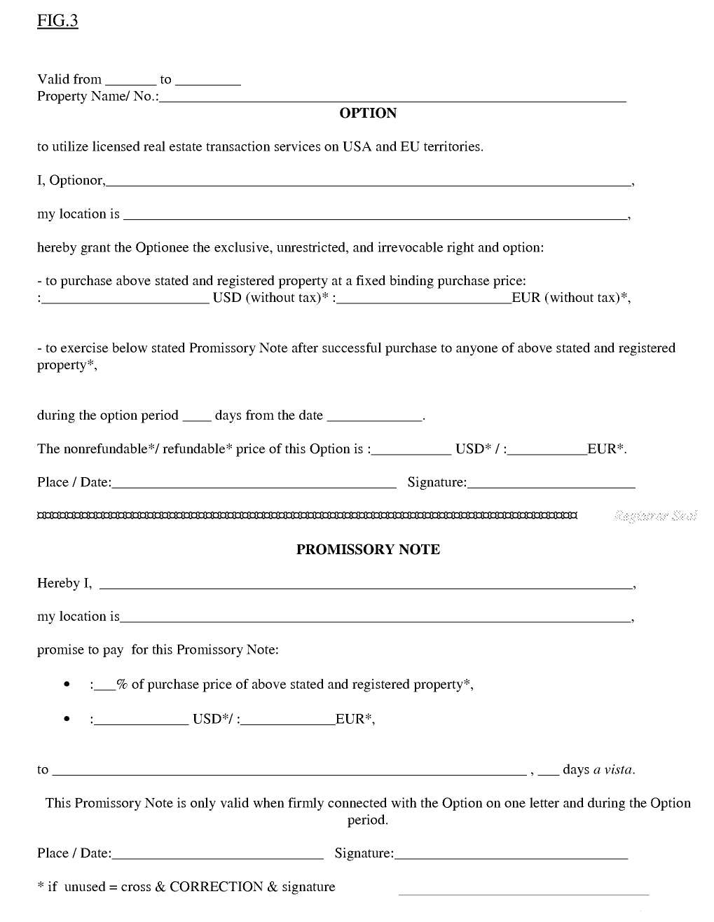

The business and trading system, the electronic unit and software system according to FIG. 1 wherein issued by Registrar or Issuer time-limited Blank Option and Bill of Exchange (BOBE) according to FIG. 3 and used functional fields:
The binding real estate price,
The consideration option price for a real estate purchase,
The commission price,
The period of the option time to exercise of commission and real estate purchase.
   The BOBE is exercised by buyer of property.

### EXAMPLE NO. 2

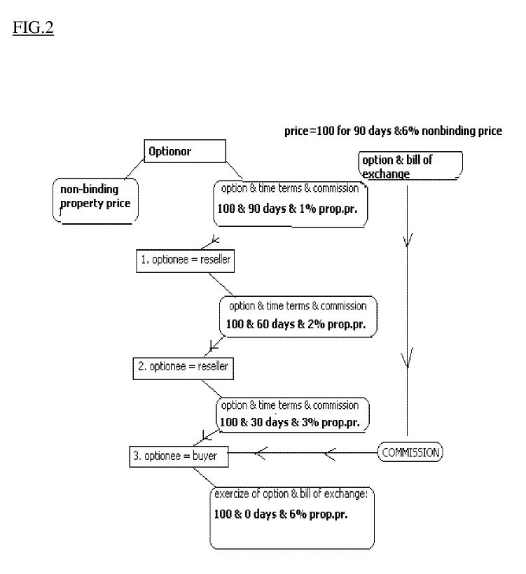

The business and trading system, the electronic unit and software system according to FIG. 2 wherein issued by Registrar or Issuer time-limited option and bill of exchange according to FIG. 3 and used functional fields:
The non-binding price of a real estate,
The period of the option time to exercise of commission and real estate purchase.
The bill of exchange binding price (compensation) for a real estate buyer.

### EXAMPLE NO. 3

The business and trading system, the electronic unit and software system containing, supporting, and using the functional fields:
The published binding real estate price,
The option price for a commission purchase (reward for an agent),
The option price for a real estate purchase,
The period of the option time for a commission and option for a real estate purchase,
The highest offered option price for a commission purchase,
The highest offered option price for a real estate purchase,
The binding commission price (bill of exchange price).

1. A method, an electronic unit and software system comprising and supporting:
obtaining or creating a collection of entitlements to use warranted real estate transaction services;
creating a pool consisting of assignable time-limited conditional blank commission forms containing an option to utilize said services;
issuing, distributing or selling of said forms as insurance tools;
collecting or recording copies of used said forms;
realizing settlements for used said services after successful transfer of ownership, lease or rights.

2. The method, the electronic unit and software system of claim 1, wherein said form or its part is transferable via endorsement.

3. The method, the electronic unit and the software system of claim 1, wherein said forms comprise blank option to buy, lease or sell any real estate.

4. The method, the electronic unit and software system of claim 1, wherein said forms comprise conditional option to extra parte commission, compensation or discount by using multilevel price marketing.

5. The method, the electronic unit and software system of claim 1, wherein said settlements for used said services cover advertising, legal status registration of property, administration, financial, legal or other service costs needed for a transfer of ownership, lease or rights.

6. The method, the electronic unit and software system of claim 1, wherein said issuing, distributing or selling is supported by the network, reference or direct marketing.

7. The method, the electronic unit and software system of claim 1, wherein said collecting or recording copies of used said forms is utilized at collecting, evaluating, recording or distribution of market price information.

8. Use of assignable time-limited blank option commission form as a part of entitlement confers the option and the right to utilize licensed real estate intermediation services to holder of said form, wherein said services are prepaid as insurance.

9. The use according to claim 8, wherein said form contains blank option to buy, lease or sell any real property.

10. The use according to claim 8, wherein said insurance covers costs, fees, charges for advertising, financial, legal services needed for the transfer of ownership, lease or rights.

11. A method, an electronic unit and a software system comprising and supporting:
obtaining or creating a collection of entitlements to use licensed real estate transaction services;
creating a pool consisting of assignable time-limited conditional blank commission forms containing an option to utilize said services against settlement;
issuing, distributing or selling of said forms;
collecting or recording copies of used said forms.

12. The method, the electronic unit and the software system of claim 11, wherein said forms include option and bill of exchange forms.

13. The method, the electronic unit and the software system of claim 11, wherein said forms comprise blank option to buy, lease or sell any real property.

14. The method, the electronic unit and the software system of claim 11, wherein said forms comprise conditional option to extra parte commission, compensation or discount by using multilevel price marketing.

15. The method, the electronic unit and the software system of claim 11, wherein said issuing and distributing of said form is supported by the network, reference or direct marketing.

16. The method, the electronic unit and the software system of claim 11, wherein said settlement is paid by holder of said form.

17. The method, the electronic unit and the software system according to claim 11, wherein said collecting or recording copies of used commission forms is used for collecting, evaluating, recording or distribution of market price information.
